(19) United States
(12) Patent Application Publication
(10) Pub. No.: US 2012/0300189 A1
(43) Pub. Date: Nov. 29, 2012

(54) LASER DISTANCE METER

(76) Inventor: Alexey V. Gulunov, Chelyabinsk (RU)

(21) Appl. No.: 13/127,879

(22) Filed: May 5, 2011

(30) Foreign Application Priority Data
Nov. 5, 2008 (RU) 2008143853
Nov. 4, 2009 (IB) PCT/IB2009/007321

(51) Int. Cl. G01C 3/02

(52) U.S. Cl. 356/3

(57) ABSTRACT

The invention relates to a laser distance meter with expanded functions, comprising a module for measuring distance, area and volume, wherein an optical axis of said module is fixed relative to a fastening point on a tripod and relative to a distance reference point, said meter also comprising a signal evaluation circuit, a microcomputer, a memory, a control panel, a screen and a battery. According to the invention, a module is provided for marking the reference axes using a pendulum and a laser fastened to the pendulum, said module, in addition to the module for measuring distance, area and volume, able to be connected for displaying the position of the axes.

### CROSS-REFERENCE TO RELATED APPPLICATION

This application claims the benefit of the priority filing date of international application no. PCT/IB2009/007321 in publication no. WO/2010/052544, and Russian application no. 2008143853 filed on Nov. 5, 2008.

### FEDERALLY SPONSORED RESEARCH:

Not Applicable

### SEQUENCE LISTING OR PROGRAM:

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to a laser distance meter with expanded functions as generically defined by the preamble to claim 1.

The invention is usable for measuring instruments for distance measurement in a direction orthogonal to the supporting axis line, in particular with automatic stabilization of the line of sight. The primary field of use of the proposed invention is measuring instruments that can be used in the construction field.

Laser distance meters (electronic-optical modules) are known which are independent laser devices. These are modern measuring instruments which now replace the traditional measuring tape. They make it possible to measure the primary dimensions of objects both inside and outside the rooms and to measure spacings with a high degree of precision [www.gsi2000.ru].

However, known laser distance meters cannot perform the projection function of a self-adjusting line of sight.

In known laser distance meters, the projection of the pointlike laser beam and the projection of the laser line are superimposed. The laser line extends perpendicularly to the beam. This is laser level LAX 100-K made by STABILA; see www.arsenaltool.ru.

However, this instrument only marks horizontal and perpendicular surfaces.

In practice, however, marking of the reference axes must be done at a specified interval. This task is very laborious when the known technology is employed.

The closest prior art, in terms of technical essence and effect attained, is a laser distance meter with expanded functions called the Leica DISTO D3. It was chosen as a prototype. The prototype contains a unit for measuring distance, surface area and volume. Its optical axis is fixed with respect to a fastening point on the tripod and with respect to a distance reference point. This unit contains a signal evaluation circuit, a microcomputer, a memory, a control panel, a screen, and a rechargeable battery. See http://www.gfk-leica.ru/construct/disto_D3.htm.

The aforementioned known laser distance meter makes it possible to measure distance, determine angles of inclination, and calculate surface area, volume, Pythagorean functions, and areas that are hard to access.

However, the known laser distance meter is not capable of simultaneously performing distance measurement and projecting a self-adjusting line of sight.

It is the object of the present invention to develop a multipurpose measuring instrument which has a laser distance meter with a leveling function. In this laser distance meter, component units present in the laser distance meter can expand functionalities by allowing a module to be added for marking reference axes (leveling module).

This object is attained by the characteristics of claim 1.

The technical outcome of the object to be attained is an optimized laser distance meter construction with expanded functions.

The production of a multipurpose measuring instrument of this kind makes it possible to simultaneously measure spacing and project a self-adjusting line of sight.

This is attained in the following way: The known laser distance meter with expanded functions includes a module for measuring distance, surface area and volume. An optical axis of this module is fixed with respect to a fastening point on a tripod and with respect to a distance reference point. The laser distance meter includes a signal evaluation circuit, a microcomputer, a memory, a control panel, a screen, and a rechargeable battery. According to the invention, the laser distance meter is additionally equipped with a module for marking the reference axes (leveling module). This leveling module includes a pendulum that self-adjusts into a vertical position. The axis of the pendulum is aligned with the optical axis of the module for measuring distance, surface area and volume. The pendulum is provided with a circuit for monitoring its position. The laser, which is provided with a circuit for its control, is fastened to the pendulum. During operation, the laser connects to a microcomputer, a signal evaluation circuit, a memory unit, a screen, and a rechargeable battery of the module for measuring distance, surface area and volume.

The pendulum axis of the leveling module of the laser distance meter with expanded functions coincides with the optical axis of the module for measuring distance, surface area and volume.

The pendulum axis of the leveling module of the laser distance meter with expanded functions can extend orthogonally to the optical axis of the module for measuring distance, surface area and volume.

The laser distance meter with expanded functions is additionally equipped with a data projector for marking the surface.

A search of patent-related and technological references was made. The results are persuasive that the proposed laser distance meter with expanded functions is unknown and cannot be read from the prior art studied. That is, the laser distance meter is novel and has the requisite level of invention.

The proposed laser distance meter with expanded functions can be produced in an arbitrary facility that is active in this field. For its production, known materials, component units, accessories, and mass-produced devices, which are produced both at home and abroad, are necessary.

Thus, the laser distance meter with expanded functions is commercially usable.

The proposed entirety of the essential characteristics of the inventive laser distance meter with expanded functions is novel, and makes it possible to attain the stated object of producing a multipurpose measuring instrument. In this multipurpose measuring instrument, the expansion of the functionalities is ensured by providing component units in the inventive laser distance meter that allows for the addition of a module for marking reference axes (leveling module).

Equipping the inventive laser distance meter with a leveling module makes it possible to create a novel multipurpose instrument. In this instrument, in addition to the typical functions of a conventional laser distance meters, such as distance measurement, determining the angle of inclination, and calculating surface area and volume, the inventive laser distance meter also functions to mark horizontal and vertical reference axes.

The inventive laser distance meter with expanded functions is provided with a leveling module that has a vertically self-adjusting pendulum. The axis of the pendulum is aligned with the optical axis of the module for measuring distance, surface area and volume. This makes it possible to expand the functionalities of known laser distance meters.

During operation, the leveling module is connected to a microcomputer, a signal evaluation circuit, a memory unit, a screen and rechargeable battery of the basic module—that is, a module for measuring distance, surface area and volume. This makes it possible to utilize the accessory component units that are present in the construction of the laser distance meter in order to perform the functions that are assigned to the leveling module. This likewise expands the functionalities of the laser distance meter, reduces the costs for the total value of both devices, namely the laser distance meter and the leveling device. It is also possible to create a compact, combined, multipurpose device that has numerous application possibilities.

The laser distance meter with expanded functions is embodied such that the axes of the pendulum of the leveling module and the axes of the module for measuring distance, surface area and volume coincide. As a result, a horizontal reference axis is embodied. It is therefore possible to mark reference axes using indications provided by the laser distance meter. This likewise expands the functionalities of the laser distance meter that has expanded functions.

The laser distance meter with expanded functions, which is embodied with a leveling module having a pendulum with orthogonally disposed axes and a module for measuring distance, surface area and volume, makes it possible to form a vertical reference axis. As such, reference axes can be marked on the basis of laser distance meter indications. This again expands the functionalities of the laser distance meter that has expanded functions.

The laser distance meter with expanded functions, which is additionally provided with a data projector, makes it possible to project data onto a surface to be marked. This increases the user-friendliness of the laser distance meter with expanded functions.

### DRAWING

The invention is described in further detail in terms of an exemplary embodiment shown in the drawing.

FIG. 1 shows the block circuit diagram of a laser distance meter with expanded functions.

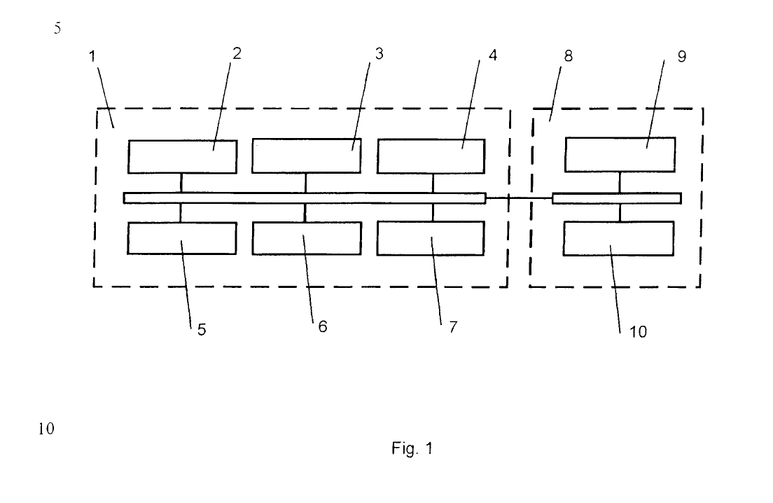

### DESCRIPTION

The laser distance meter with expanded functions comprises a module 1 for measuring distance, surface area and volume. The optical axis of this module 1 is fixed with respect to a fastening point on a tripod and with respect to a distance reference point. The module 1 includes a circuit 2 for signal evaluation, a microcomputer 3, memory 4, a control panel 5, a screen 6, a rechargeable battery 7, and a module 8 for marking reference axes (leveling module). The leveling module 8 includes a vertically self-adjusting pendulum. The pendulum axis is aligned with the optical axis of the module 1 for measuring distance, surface area and volume. The pendulum is provided both with a circuit 9 for monitoring its position and with a laser fastened to the pendulum. The laser is equipped with a circuit 10 for controlling it. During operation, the laser is connected to the microcomputer 3, the signal evaluation circuit 2, a memory unit 4, a screen 6, and a rechargeable battery 7 of the module 1 for measuring distance, surface area and volume. The control panel 5 acts as a control panel for both the module 1 for measuring distance, surface area and volume and the leveling module 8.

The pendulum axis of the leveling module 8 coincides with the optical axis of the module 1 for measuring distance, surface area and volume.

The pendulum axis of the leveling module 8 can extend orthogonally to the optical axis of the module 1 for measuring distance, surface area and volume.

The mode of operation of the laser distance meter with expanded functions involves the operation of the laser distance meter with a leveling function, and specifically in the mode of operation for marking the reference axes at a predetermined interval. The mode of operation is as follows: A key is actuated that switches on the control circuit 9 of the laser of the leveling module 8 and the circuit 10 for monitoring the pendulum position at the microcomputer 3, the circuit 2 for signal evaluation, the memory unit 4, the control panel 5, the screen 6, and the rechargeable battery 7. The microcomputer 3 outputs a control instruction to the module 1 for measuring distance, surface area and volume to switch on a correction of the reference point for spacing from the leveling module's 8 axis of sight and from the axis of the fastening point on the tripod. These axes coincide. Then, the operation for marking the reference axes at a predetermined interval can be initiated (operations that are intrinsic to the laser distance meter and the leveling device).

During operation, in conjunction with the marking of the reference axes, the pendulum axis coincides with the optical axis of the module 1 for measuring distance, surface area and volume. The distance meter is disposed such that its optical axis is vertical. The instruction for switching on the leveling module 8 is issued via the control panel 5,. The leveling module's 8 pendulum adjusts to the plumb position. The laser fastened to the pendulum projects a horizontal reference axis. From the measurement data of the laser distance meter, the reference axes are marked.

As long as the operation in conjunction with the marking of the reference axes is performed, the pendulum axis extends orthogonally to the optical axis of the module 1 for measuring distance, surface area and volume. The distance meter is disposed such that its optical axis extends horizontally. The instruction for switching on the leveling module 8 is tripped via the control panel 5. The leveling module's 8 pendulum adjusts itself into the vertical position. The laser fastened to the pendulum projects a vertical reference axis. Based on the measuring indications provided by the laser distance meter, the reference axes is marked.

If the inventive laser distance meter with expanded functions does not operate to mark reference axes at a predetermined interval, it suffices to issue a command, via the control panel 5, to switch off the leveling module 8. Thereafter, the laser distance meter can operate conventionally.

If the laser distance meter of the invention with expanded functions operates in the functional mode of a leveling device, then for that purpose, it suffices to switch on only the leveling module 8.

The proposed laser distance meter with expanded functions is compact and simple to use and ensures a number of measuring functions with high precision. The laser distance meter is a multipurpose device, which reduces the effort involved in conjunction with marking the reference axes at a predetermined spacing.

The following are claimed:

1. A laser distance meter with expanded functions, which comprises a module (1) for measuring distance, surface area and volume, an optical axis of this module (1) being fixed with respect to a fastening point on a tripod and with respect to a distance reference point, and which has a signal evaluation circuit (2), a microcomputer (3), a memory unit (4), a control panel (5), a screen (6), and a rechargeable battery (7), characterized in that
the laser distance meter with expanded functions is additionally provided with a module (8) for marking reference axes (leveling module), which contains a vertically self-adjusting pendulum;
the axis of the pendulum is aligned with the optical axis of the module (1) for measuring distance, surface area and volume;
the pendulum is provided with a circuit (9) for monitoring its position and with a laser fastened to the pendulum, and the laser is equipped with a control circuit (10); and
the laser can be connected during operation to the microcomputer (3), the signal evaluation circuit (2), the memory unit (4), the screen (6), and the rechargeable battery (7) of the module (1) for measuring distance, surface area and volume.

2. The laser distance meter with expanded functions as defined by claim 1, characterized in that the pendulum axis of the leveling module (8) coincides with the optical axis of the module (1) for measuring distance, surface area and volume.

3. The laser distance meter with expanded functions as defined by claim 1, characterized in that the pendulum axis of the leveling module (8) extends orthogonally to the optical axis of the module (1) for measuring distance, surface area and volume.

4. The laser distance meter with expanded functions as defined by claim 1, characterized in that it is additionally equipped with a data projector for surface marking.
